(19) United States
(12) Patent Application Publication
(10) Pub. No.: US 2013/0342496 A1
(43) Pub. Date: Dec. 26, 2013

(54) SENSING CIRCUIT OF A TOUCH PANEL AND OPERATION METHOD OF A SENSING CIRCUIT OF A TOUCH PANEL

(71) Applicant: Kun-Hua Tsai, Tainan City (TW)

(72) Inventor: Kun-Hua Tsai, Tainan City (TW)

(21) Appl. No.: 13/586,883

(22) Filed: Aug. 16, 2012

(30) Foreign Application Priority Data
Jun. 21, 2012 (CN) 201210210307.5

(51) Int. Cl. G06F 3/044

(52) U.S. Cl. 345/174

(57) ABSTRACT

A sensing circuit includes a capacitor array, a comparator, and a processing unit. The comparator compares a detection voltage of each sensing unit with a common voltage of the touch panel to generate a corresponding comparison result. The processing unit generates a corresponding adjustment signal according to the corresponding comparison result. The capacitor array executes a corresponding operation on a present exponent n to generate a corresponding compensation capacitor according to the corresponding adjustment signal, and the capacitor array generates a present compensation capacitor according to a previous compensation capacitor generated by the capacitor array and the corresponding compensation capacitor. Thus, the present invention not only can quickly make a compensation capacitor generated by the capacitor array converge toward capacitor variation generated by the sensing unit, but can also reduce a delay problem of compensating capacitor caused by environmental noise interference.

### BACKGROUND OF THE INVENTION

1. Field of the Invention

The present invention relates a sensing circuit of a touch panel and an operation method of a sensing circuit of a touch panel, and particularly to a sensing circuit of a touch panel and an operation method of a sensing circuit of a touch panel that not only can quickly make a compensation capacitor generated by a capacitor array converge toward capacitor variation generated by the sensing unit, but can also reduce a delay problem of compensating capacitor caused by environmental noise interference.

2. Description of the Prior Art

Please refer to FIG. 1 and FIG. 2. FIG. 1 is a diagram illustrating a compensating capacitor process of a fixed times capacitor compensation algorithm according to the prior art, and FIG. 2 is a diagram illustrating a compensating capacitor process of the fixed times capacitor compensation algorithm when capacitor variation caused by an object is not a fixed value. As shown in FIG. 1, when a sensing unit of a touch panel is touched by an object, the sensing unit generates capacitor variation (e.g. the capacitor variation is 110). At first, the fixed times capacitor compensation algorithm generates a compensation capacitor corresponding to 128 (because the sensing circuit of the touch panel has an 8-bit capacitor array). Because the compensation capacitor corresponding to 128 is greater than the capacitor variation 110, then the fixed times capacitor compensation algorithm generates a compensation capacitor corresponding to 64 (128/2), and subtracts the compensation capacitor corresponding to 64 from the compensation capacitor corresponding to 128 to generate a compensation capacitor corresponding to 64. Because the compensation capacitor corresponding to 64 is smaller than the capacitor variation 110, the fixed times capacitor compensation algorithm generates a compensation capacitor corresponding to 32 (64/2), and adds the compensation capacitor corresponding to 32 to the compensation capacitor corresponding to 64 to generate a compensation capacitor corresponding to 96. Because the compensation capacitor corresponding to 96 is smaller than the capacitor variation 110, the fixed times capacitor compensation algorithm generates a compensation capacitor corresponding to 16 (32/2), and adds the compensation capacitor corresponding to 16 to the compensation capacitor corresponding to 96 to generate a compensation capacitor corresponding to 112. Because the compensation capacitor corresponding to 112 is greater than the capacitor variation 110, the fixed times capacitor compensation algorithm generates a compensation capacitor corresponding to 8 (16/2), and subtracts the compensation capacitor corresponding to 8 from the compensation capacitor corresponding to 112 to generate a compensation capacitor corresponding to 104. Because the compensation capacitor corresponding to 104 is smaller than the capacitor variation 110, the fixed times capacitor compensation algorithm generates a compensation capacitor corresponding to 4 (8/2), and adds the compensation capacitor corresponding to 4 to the compensation capacitor corresponding to 104 to generate a compensation capacitor corresponding to 108. Because the compensation capacitor corresponding to 108 is smaller than the capacitor variation 110, the fixed times capacitor compensation algorithm generates a compensation capacitor corresponding to 2 (4/2), and adds the compensation capacitor corresponding to 2 to the compensation capacitor corresponding to 108 to generate a compensation capacitor corresponding to 110. Because the compensation capacitor corresponding to 110 is equal to the capacitor variation 110, the fixed times capacitor compensation algorithm stops continuous operation.

The fixed times capacitor compensation algorithm in FIG. 1 can ensure that the sensing circuit can generate the compensation capacitor corresponding to the capacitor variation 110 within 8 times operation (because the sensing circuit of the touch panel has the 8-bit capacitor array). As shown in FIG. 2, when capacitor variation caused by the object is not a fixed value (e.g. the capacitor variation generated by the object is 110, 100, 103, 101, 105, and 100 in turn) due to vibration of the object or environmental noise of the sensing unit, the fixed times capacitor compensation algorithm of the prior art can ensure that the sensing circuit generates a compensation capacitor corresponding to the capacitor variation generated by the sensing unit within 8 times operation. As shown in FIG. 2, when the capacitor variation caused by the object is not a fixed value, the fixed times capacitor compensation algorithm of the prior art first generates a compensation capacitor corresponding to 128, and then gradually adjusts a compensation capacitor generated by the capacitor array of the sensing circuit. Thus, for a user, the fixed times capacitor compensation algorithm of the prior art may spend more time on determining the capacitor variation generated by the sensing unit, so that a report rate of the touch panel is decreased.

### SUMMARY OF THE INVENTION

An embodiment provides a sensing circuit of a touch panel. The sensing circuit includes a capacitor array, a comparator, and a processing unit. The capacitor array is used for coupling to a plurality of sensing units of the touch panel. The comparator is coupled to each sensing unit of the touch panel and the capacitor array for comparing a detection voltage of the sensing unit with a common voltage of the touch panel to generate a corresponding comparison result. The processing unit is used for generating a corresponding adjustment signal to the capacitor array according to the corresponding comparison result. The capacitor array executes a corresponding operation on a present exponent n to generate a corresponding compensation capacitor according to the corresponding adjustment signal, and the capacitor array generates a present compensation capacitor according to a previous compensation capacitor generated by the capacitor array and the corresponding compensation capacitor, where n is an integer larger than or equal to 0.

Another embodiment provides an operation method of a sensing circuit of a touch panel is disclosed. The sensing circuit includes capacitor array, a comparator, and a processing unit. The method includes the comparator comparing a detection voltage of each sensing unit of the touch panel with a common voltage of the touch panel to generate a corresponding comparison result; the processing unit generating a corresponding adjustment signal to the capacitor array according to the corresponding comparison result; the capacitor array executing a corresponding operation on a present exponent n to generate a corresponding compensation capacitor according to the corresponding adjustment signal, wherein n is an integer larger than or equal to 0; and the capacitor array generating a present compensation capacitor according to a previous compensation capacitor generated by the capacitor array and the corresponding compensation capacitor.

The present invention provides a sensing circuit of a touch panel and an operation method of a sensing circuit of a touch panel. In a practical application of the touch panel, when capacitor variation generated by a sensing unit is larger, the sensing circuit and the operation method of the present invention can quickly make a compensation capacitor generated by a capacitor array converge toward the capacitor variation generated by the sensing unit. In addition, when the capacitor variation generated by the sensing unit is smaller, the capacitor array does not need to start to generate the compensation capacitor from the initial value, and then gradually adjust the compensation capacitor generated by the capacitor array to match the capacitor variation generated by the sensing unit. Thus, the present invention not only can quickly make the compensation capacitor generated by the capacitor array converge toward the capacitor variation generated by the sensing unit, but can also reduce a delay problem of compensating capacitor caused by environmental noise interference. Therefore, the present invention can increase a report rate of the touch panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a compensating capacitor process of a fixed times capacitor compensation algorithm according to the prior art.

FIG. 2 is a diagram illustrating a compensating capacitor process of the fixed times capacitor compensation algorithm when capacitor variation caused by an object is not a fixed value.

FIG. 3 is a diagram illustrating a sensing circuit of a touch panel according to an embodiment.

FIG. 4 is a diagram illustrating an object touching a sensing unit.

FIG. 5 is a diagram illustrating a compensating capacitor process of the sensing circuit.

FIG. 6 is a diagram illustrating a compensating capacitor process of the sensing circuit when capacitor variation caused by the object is not a fixed value.

FIG. 7 and FIG. 8 are flowcharts illustrating an operation method of a sensing circuit of a touch panel according to another embodiment.

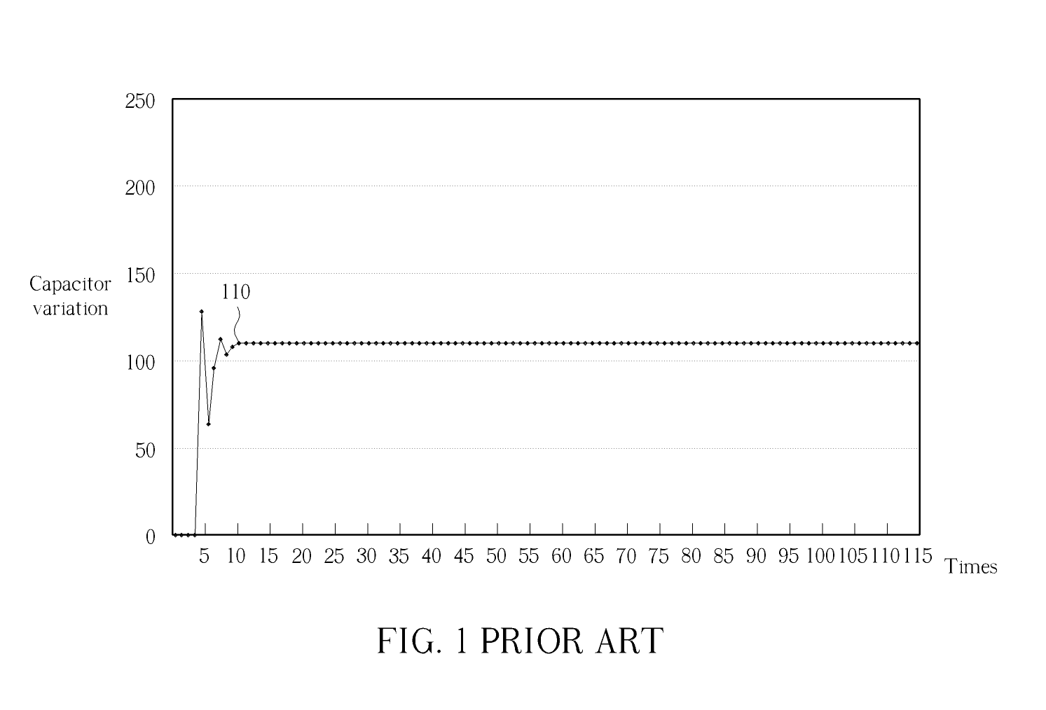

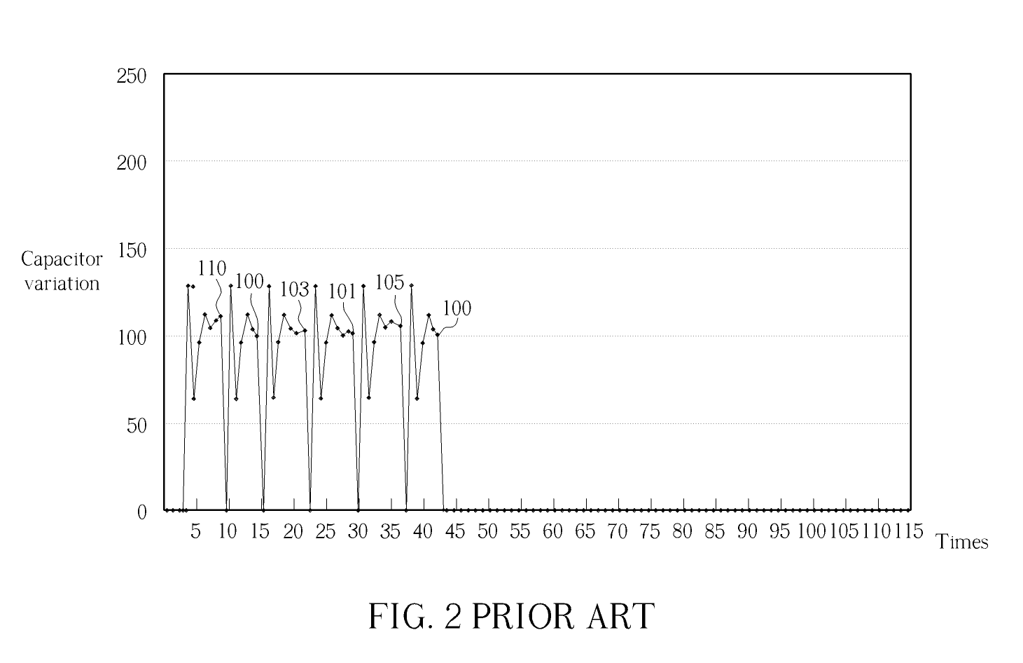

### DETAILED DESCRIPTION

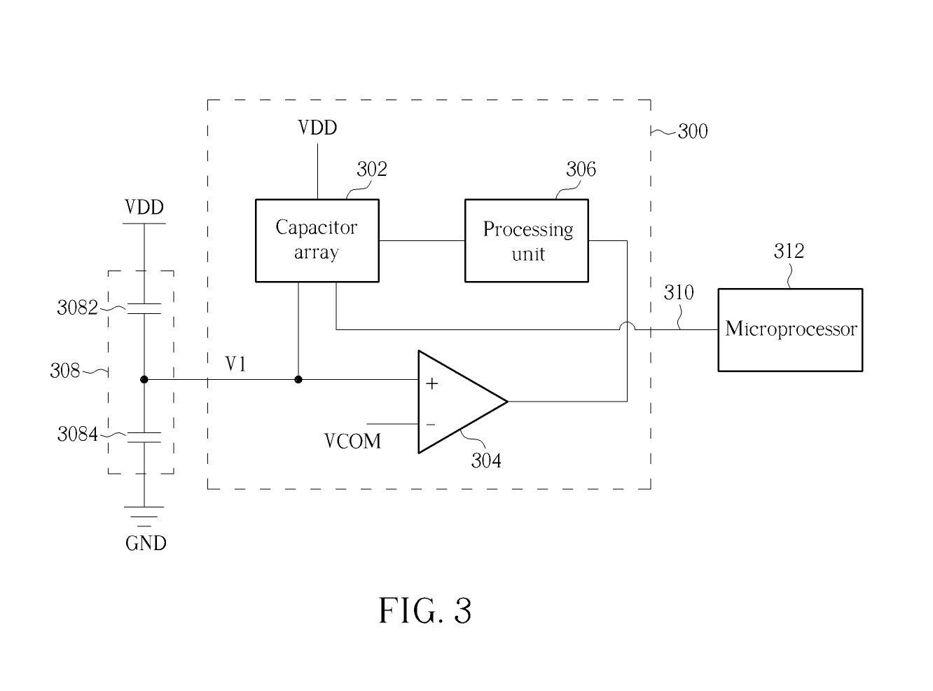

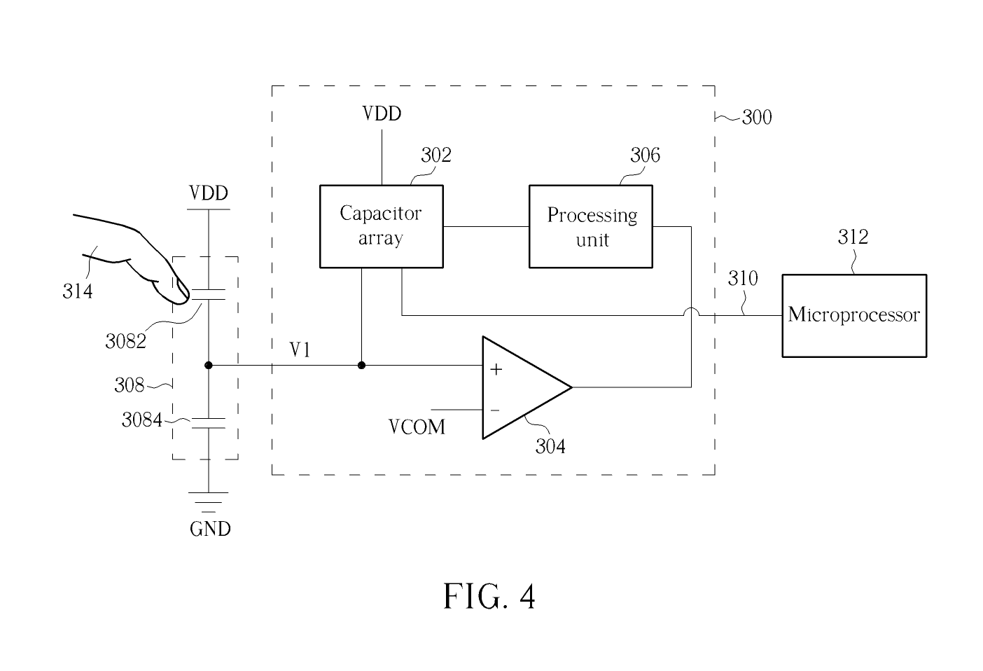

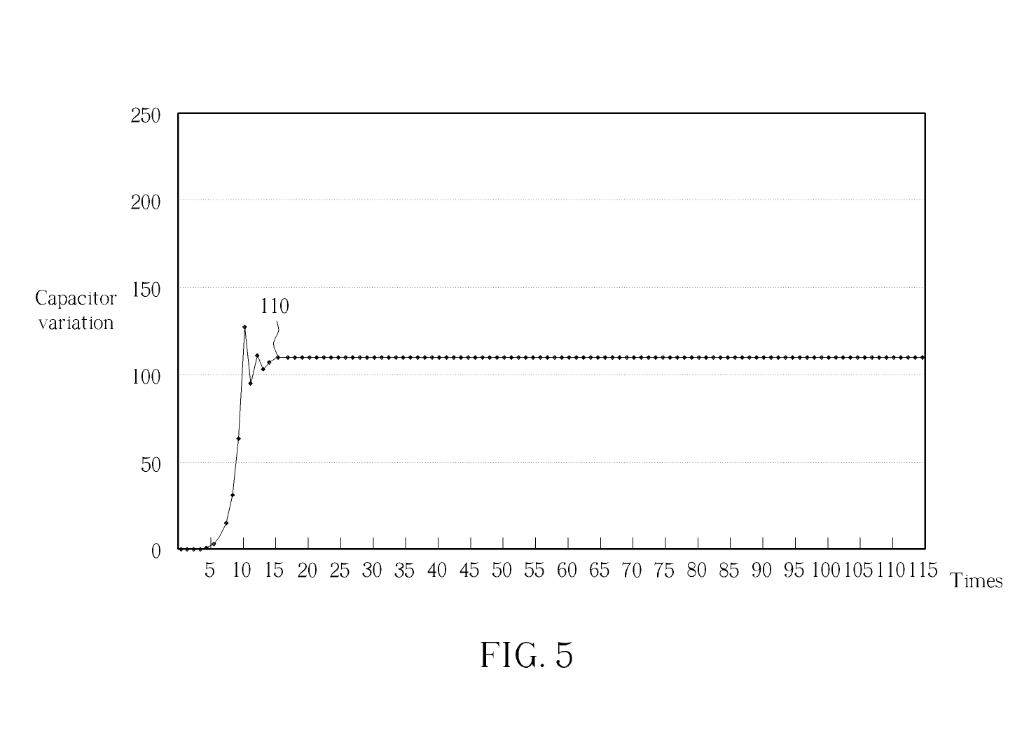

Please refer to FIG. 3, FIG. 4, and FIG. 5. FIG. 3 is a diagram illustrating a sensing circuit 300 of a touch panel according to an embodiment, FIG. 4 is a diagram illustrating an object touching a sensing unit, and FIG. 5 is a diagram illustrating a compensating capacitor process of the sensing circuit 300. The sensing circuit 300 includes a capacitor array 302, a comparator 304, and a processing unit 306. The capacitor array 302 is used for coupling to a plurality of sensing units of the touch panel. Because each sensing unit of the plurality of sensing units is the same, only a sensing unit 308 in FIG. 3 is utilized to illustrate a function of the sensing circuit 300, where the sensing unit 308 includes a first capacitor 3082 and a second capacitor 3084, and a capacitance of the first capacitor 3082 is the same as a capacitance of the second capacitor 3084. In addition, a capacitance of a compensation capacitor generated by the capacitor array 302 can be transported to a microprocessor 312 through a pin 310, where the microprocessor 312 can execute a corresponding operation on the capacitance of the compensation capacitor generated by the capacitor array 302, and the capacitor array 302 is an 8-bit capacitor array. That is to say, the capacitor array 302 can provide 256 (2⁸) compensation capacitors. But, the present invention is not limited to the capacitor array 302 being the 8-bit capacitor array. The comparator 304 is coupled to each sensing unit of the touch panel and the capacitor array 302 for comparing a detection voltage V1 of each sensing unit with a common voltage VCOM of the touch panel to generate a corresponding comparison result. The processing unit 306 is used for generating a corresponding adjustment signal to the capacitor array 302 according to the corresponding comparison result. In addition, VDD is a supply voltage and GND is ground.

As shown in FIG. 3, when the sensing unit 308 is not touched by an object, a voltage (the detection voltage V1) of a positive input terminal of the comparator 304 is the same as a voltage (the common voltage VCOM) of a negative input terminal, where the detection voltage V1 is determined according to capacitor variation of the sensing unit 308 and a present compensation capacitor of the capacitor array 302. That is to say, when the capacitor variation of the sensing unit 308 is equal to the present compensation capacitor of the capacitor array 302, the detection voltage V1 is equal to the common voltage VCOM; when the capacitor variation of the sensing unit 308 is greater than the present compensation capacitor of the capacitor array 302, the detection voltage V1 is smaller than the common voltage VCOM; when the capacitor variation of the sensing unit 308 is smaller than the present compensation capacitor of the capacitor array 302, the detection voltage V1 is greater than the common voltage VCOM. As shown in FIG. 4 and FIG. 5, when the sensing unit 308 is touched by an object 314 (e.g. a finger), the sensing unit 308 generates capacitor variation (e.g. the capacitor variation is 110), resulting in the voltage (the detection voltage V1) of the positive input terminal of the comparator 304 being smaller than the voltage (the common voltage VCOM) of the negative input terminal of the comparator 304. But, the present invention is not limited to the capacitor variation being 110. As shown in FIG. 4 and FIG. 5, when the voltage of the positive input terminal of the comparator 304 is smaller than the voltage of the negative input terminal of the comparator 304, the comparator 304 generates a first comparison result. Then, the processing unit 306 generates a first adjustment signal to the capacitor array 302 according to the first comparison result. At first, the capacitor array 302 generates a compensation capacitor corresponding to 1 (2⁰) according to the first adjustment signal, and adds the compensation capacitor corresponding to 1 to an initial value 0 to generate a compensation capacitor corresponding to 1. Meanwhile, a present exponent n is 0. Because the compensation capacitor corresponding to 1 is smaller than the capacitor variation 110, the voltage of the positive input terminal of the comparator 304 is smaller than the voltage of the negative input terminal of the comparator 304. When the voltage of the positive input terminal of the comparator 304 is smaller than the voltage of the negative input terminal of the comparator 304, the comparator 304 continuously generates the first comparison result. Then, the processing unit 306 generates the first adjustment signal to the capacitor array 302 according to the first comparison result. The capacitor array 302 progressively increases the present exponent 0 to generate a compensation capacitor corresponding to 2 (2⁰⁺¹) according to the first adjustment signal, and adds the compensation capacitor corresponding to 2 to the compensation capacitor corresponding to 1 (the previous compensation capacitor) to generate a compensation capacitor corresponding to 3. Meanwhile, the present exponent is 1. Because the compensation capacitor corresponding to 3 is smaller than the capacitor variation 110, the voltage of the positive input terminal of the comparator 304 is smaller than the voltage of the negative input terminal of the comparator 304, resulting in the comparator 304 generating the first comparison result. Then, the processing unit 306 generates the first adjustment signal to the capacitor array 302 according to the first comparison result. The capacitor array 302 progressively increases the present exponent 1 to generate a compensation capacitor corresponding to 4 (2¹⁺¹) according to the first adjustment signal, and adds the compensation capacitor corresponding to 4 to the compensation capacitor corresponding to 3 (the previous compensation capacitor) to generate a compensation capacitor corresponding to 7. Meanwhile, the present exponent is 2. Because the compensation capacitor corresponding to 7 is smaller than capacitor variation 110, the voltage of the positive input terminal of the comparator 304 is smaller than the voltage of the negative input terminal of the comparator 304, resulting in the comparator 304 generating the first comparison result. Then, the processing unit 306 generates the first adjustment signal to the capacitor array 302 according to the first comparison result. The capacitor array 302 progressively increases the present exponent 2 to generate a compensation capacitor corresponding to 8 (2²⁺¹) according to the first adjustment signal, and adds the compensation capacitor corresponding to 8 to the compensation capacitor corresponding to 7 (the previous compensation capacitor) to generate a compensation capacitor corresponding to 15. Meanwhile, the present exponent is 3. Because the compensation capacitor corresponding to 15 is smaller than the capacitor variation 110, the voltage of the positive input terminal of the comparator 304 is smaller than the voltage of the negative input terminal of the comparator 304, resulting in the comparator 304 generating the first comparison result. Then, the processing unit 306 generates the first adjustment signal to the capacitor array 302 according to the first comparison result. The capacitor array 302 progressively increases the present exponent 3 to generate a compensation capacitor corresponding to 16 (2³⁺¹) according to the first adjustment signal, and adds the compensation capacitor corresponding to 16 to the compensation capacitor corresponding to 15 (the previous compensation capacitor) to generate a compensation capacitor corresponding to 31. Meanwhile, the present exponent is 4. Because the compensation capacitor corresponding to 31 is smaller than the capacitor variation 110, the voltage of the positive input terminal of the comparator 304 is smaller than the voltage of the negative input terminal of the comparator 304, resulting in the comparator 304 generating the first comparison result. Then, the processing unit 306 generates the first adjustment signal to the capacitor array 302 according to the first comparison result. The capacitor array 302 progressively increases the present exponent 4 to generate a compensation capacitor corresponding to 32 (2⁴⁺¹) according to the first adjustment signal, and adds the compensation capacitor corresponding to 32 to the compensation capacitor corresponding to 31 (the previous compensation capacitor) to generate compensation capacitor corresponding to 63. Meanwhile, the present exponent is 5. Because the compensation capacitor corresponding to 63 is smaller than the capacitor variation 110, the voltage of the positive input terminal of the comparator 304 is smaller than the voltage of the negative input terminal of the comparator 304, resulting in the comparator 304 generating the first comparison result. Then, the processing unit 306 generates the first adjustment signal to the capacitor array 302 according to the first comparison result. The capacitor array 302 progressively increases the present exponent 5 to generate a compensation capacitor corresponding to 64 (2⁵⁺¹) according to the first adjustment signal, and adds a compensation capacitor corresponding to 64 to the compensation capacitor corresponding to 63 (the previous compensation capacitor) to generate a compensation capacitor corresponding to 127. Meanwhile, the present exponent is 6. Because the compensation capacitor corresponding to 127 is greater than the capacitor variation 110, the voltage of the positive input terminal of the comparator 304 is greater than the voltage of the negative input terminal of the comparator 304, resulting in the comparator 304 generating a second comparison result. Then, the processing unit 306 generates a second adjustment signal to the capacitor array 302 according to the second comparison result. The capacitor array 302 progressively decreases the present exponent 6 to generate a compensation capacitor corresponding to 32 (2⁶⁻¹) according to the second adjustment signal, and subtracts the compensation capacitor corresponding to 32 from the compensation capacitor corresponding to 127 (the previous compensation capacitor) to generate a compensation capacitor corresponding to 95. Meanwhile, the present exponent is 5. Because the compensation capacitor corresponding to 95 is smaller than the capacitor variation 110, the voltage of the positive input terminal of the comparator 304 is smaller than the voltage of the negative input terminal of the comparator 304, resulting in the comparator 304 generating the first comparison result. Then, the processing unit 306 generates the first adjustment signal to the capacitor array 302 according to the first comparison result. The capacitor array 302 progressively decreases the present exponent 5 to generate a compensation capacitor corresponding to 16 (2⁵⁻¹) according to the first adjustment signal, and adds the compensation capacitor corresponding to 16 to the compensation capacitor corresponding to 95 (the previous compensation capacitor) to generate a compensation capacitor corresponding to 111. Meanwhile, the present exponent is 4. Because the compensation capacitor corresponding to 111 is greater than the capacitor variation 110, the voltage of the positive input terminal of the comparator 104 is greater than the voltage of the negative input terminal of the comparator 104, resulting in the comparator 304 generating the second comparison result. Then, the processing unit 306 generates the second adjustment signal to the capacitor array 302 according to the second comparison result. The capacitor array 302 progressively decreases present exponent 4 to generate a compensation capacitor corresponding to 8 (2⁴⁻¹) according to the second adjustment signal, and subtracts the compensation capacitor corresponding to 8 from the compensation capacitor corresponding to 111 (the previous compensation capacitor) to generate a compensation capacitor corresponding to 103. Meanwhile, the present exponent is 3. Because the compensation capacitor corresponding to 103 is smaller than the capacitor variation 110, the voltage of the positive input terminal of the comparator 104 is smaller than the voltage of the negative input terminal of the comparator 104, resulting in the comparator 304 generating the first comparison result. Then, the processing unit 306 generates the first adjustment signal to the capacitor array 302 according to the first comparison result. The capacitor array 302 progressively decreases the present exponent 3 to generate a compensation capacitor corresponding to 4 (2³⁻¹) according to the first adjustment signal, and adds the compensation capacitor corresponding to 4 to the compensation capacitor corresponding to 103 (the previous compensation capacitor) to generate a compensation capacitor corresponding to 107. Meanwhile, the present exponent is 2. Because the compensation capacitor corresponding to 107 is smaller than the capacitor variation 110, the voltage of the positive input terminal of the comparator 104 is smaller than the voltage of the negative input terminal of the comparator 104, resulting in the comparator 304 generating the first comparison result. Then, the processing unit 306 generates the first adjustment signal to the capacitor array 302 according to the first comparison result. The capacitor array 302 progressively decreases the present exponent 2 to generate a compensation capacitor corresponding to 2 (2²⁻¹) according to the first adjustment signal, and adds the compensation capacitor corresponding to 2 to the compensation capacitor corresponding to 107 (the previous compensation capacitor) to generate a compensation capacitor corresponding to 109. Meanwhile, the present exponent is 1. Because the compensation capacitor corresponding to 109 is smaller than the capacitor variation 110, the voltage of the positive input terminal of the comparator 104 is smaller than the voltage of the negative input terminal of the comparator 104, resulting in the comparator 304 generating the first comparison result. Then, the processing unit 306 generates the first adjustment signal to the capacitor array 302 according to the first comparison result. The capacitor array 302 progressively decreases present exponent 1 to generate a compensation capacitor corresponding to 1 (2¹⁻¹) according to the first adjustment signal, and adds the compensation capacitor corresponding to 1 to the compensation capacitor corresponding to 109 (the previous compensation capacitor) to generate a compensation capacitor corresponding to 110. Because the compensation capacitor corresponding to 110 is equal to the capacitor variation 110, the voltage (the detection voltage V1) of the positive input terminal of the comparator 304 is equal to the voltage (the common voltage VCOM) of the negative input terminal, resulting in the comparator 304 not generating any comparison result. That is to say, the capacitor array 302 can maintain the previous compensation capacitor (the compensation capacitor corresponding to 110).

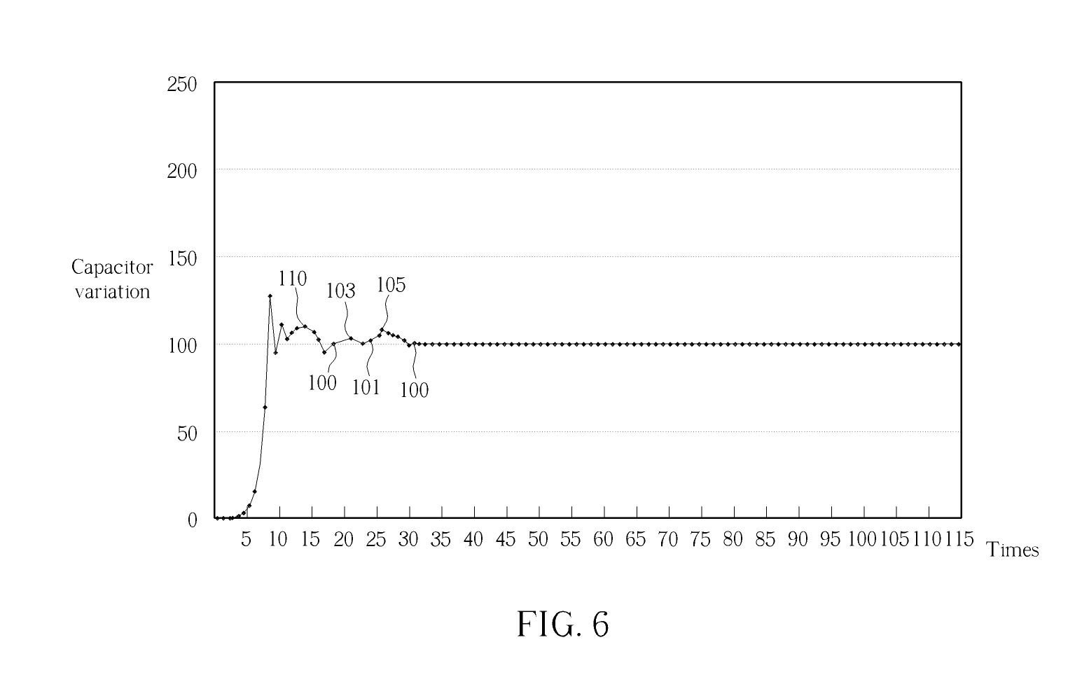

Please refer to FIG. 6. FIG. 6 is a diagram illustrating a compensating capacitor process of the sensing circuit 300 when capacitor variation caused by the object 314 is not a fixed value. As shown in FIG. 6, when the capacitor variation caused by the object 314 is not a fixed value due to vibration of the object 314 or environmental noise of the sensing unit 308 (e.g. the capacitor variation generated by the object 314 is 110, 100, 103, 101, 105, and 100 in turn), the sensing circuit 300 does not need to start to generate a compensation capacitor from the initial value 0, and then gradually adjust a compensation capacitor generated by the capacitor array 302 to match the capacitor variation generated by the sensing unit 308. Therefore, in a practical application of the touch panel, the compensating capacitor process of the sensing circuit 300 can quickly determine the capacitor variation generated by the sensing unit 308 to increase a report rate of the touch panel.

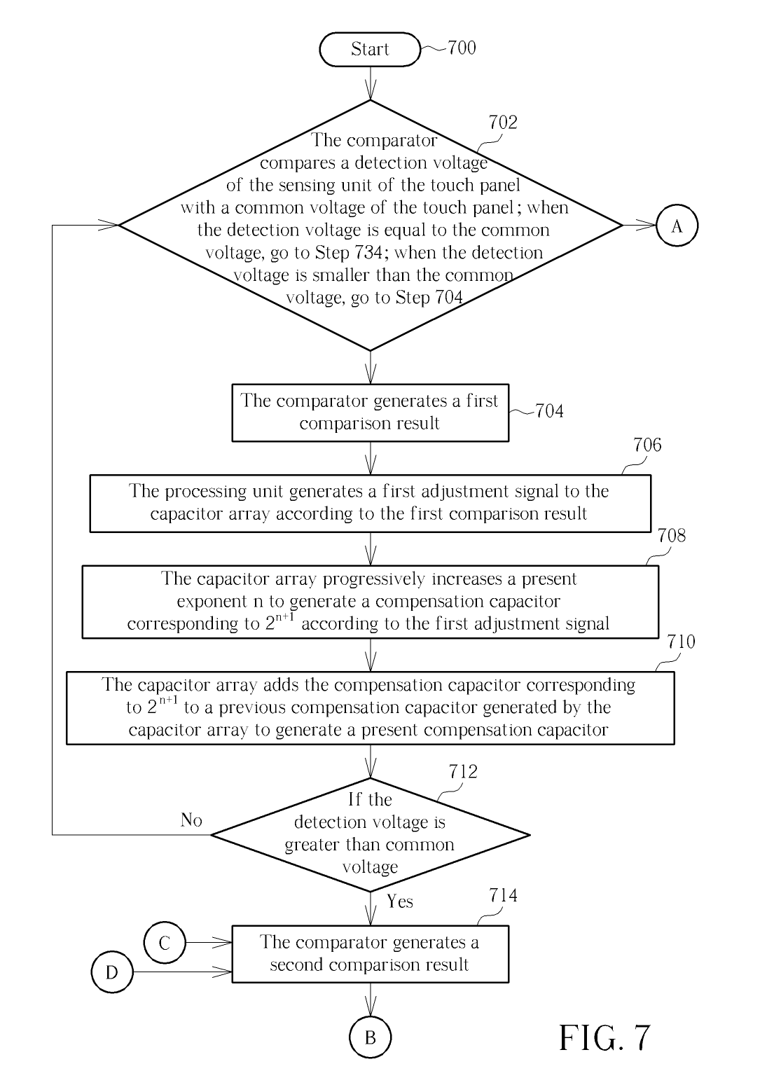

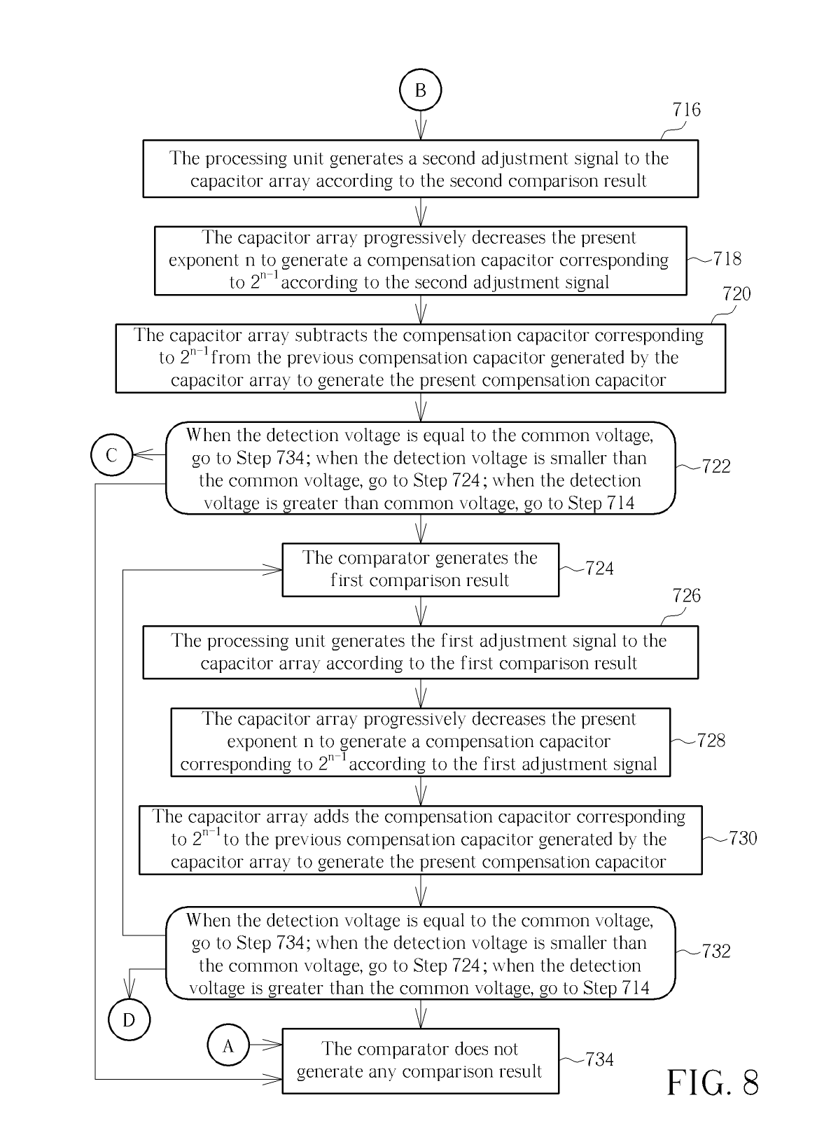

Please refer to FIG. 3, FIG. 4, FIG. 5, FIG. 6, FIG. 7, and FIG. 8. FIG. 7 and FIG. 8 are flowcharts illustrating an operation method of a sensing circuit of a touch panel according to another embodiment. The method in FIG. 7 and FIG. 8 is illustrated using the sensing circuit 300 in FIG. 3. Detailed steps are as follows:

Step 700: Start.

Step 702: The comparator 304 compares a detection voltage V1 of the sensing unit 308 of the touch panel with a common voltage VCOM of the touch panel; when the detection voltage V1 is equal to the common voltage VCOM, go to Step 734; when the detection voltage V1 is smaller than the common voltage VCOM, go to Step 704.

Step 704: The comparator 304 generates a first comparison result.

Step 706: The processing unit 306 generates a first adjustment signal to the capacitor array 302 according to the first comparison result.

Step 708: The capacitor array 302 progressively increases a present exponent n to generate a compensation capacitor corresponding to 2ⁿ⁺¹ according to the first adjustment signal.

Step 710: The capacitor array 302 adds the compensation capacitor corresponding to 2ⁿ⁺¹ to a previous compensation capacitor generated by the capacitor array 302 to generate a present compensation capacitor.

Step 712: If the detection voltage V1 is greater than common voltage VCOM; if yes, go to Step 714; if no, go to Step 702.

Step 714: The comparator 304 generates a second comparison result.

Step 716: The processing unit 306 generates a second adjustment signal to the capacitor array 302 according to the second comparison result.

Step 718: The capacitor array 302 progressively decreases the present exponent n to generate a compensation capacitor corresponding to 2ⁿ⁻¹ according to the second adjustment signal.

Step 720: The capacitor array 302 subtracts the compensation capacitor corresponding to 2ⁿ⁻¹ from the previous compensation capacitor generated by the capacitor array 302 to generate the present compensation capacitor.

Step 722: When the detection voltage V1 is equal to the common voltage VCOM, go to Step 734; when the detection voltage V1 is smaller than the common voltage VCOM, go to Step 724; when the detection voltage V1 is greater than common voltage VCOM, go to Step 714.

Step 724: The comparator 304 generates the first comparison result.

Step 726: The processing unit 306 generates the first adjustment signal to the capacitor array 302 according to the first comparison result.

Step 728: The capacitor array 302 progressively decreases the present exponent n to generate a compensation capacitor corresponding to 2ⁿ⁻¹ according to the first adjustment signal.

Step 730: The capacitor array 302 adds the compensation capacitor corresponding to 2ⁿ⁻¹ to the previous compensation capacitor generated by the capacitor array 302 to generate the present compensation capacitor.

Step 732: When the detection voltage V1 is equal to the common voltage VCOM, go to Step 734; when the detection voltage V1 is smaller than the common voltage VCOM, go to Step 724; when the detection voltage V1 is greater than the common voltage VCOM, go to Step 714.

Step 734: The comparator 304 does not generate any comparison result.

In Step 702, as shown in FIG. 3, when the detection voltage V1 is equal to the common voltage VCOM (that is, the sensing unit 308 is not touched by an object), the comparator 304 does not any comparison result. That is to say, the capacitor array 302 can maintain the previous compensation capacitor, where the detection voltage V1 is determined according to capacitor variation of the sensing unit 308 and the present compensation capacitor of the capacitor array 302. That is to say, when the capacitor variation of the sensing unit 308 is equal to the present compensation capacitor of the capacitor array 302, the detection voltage V1 is equal to the common voltage VCOM; when the capacitor variation of the sensing unit 308 is greater than the present compensation capacitor of the capacitor array 302, the detection voltage V1 is smaller than the common voltage VCOM; when the capacitor variation of the sensing unit 308 is smaller than present compensation capacitor of the capacitor array 302, the detection voltage V1 is greater than the common voltage VCOM. In Step 702, as shown in FIG. 4, when the sensing unit 308 is touched by the object 314 (e.g. a finger), the sensing unit 308 generates capacitor variation (e.g. the capacitor variation is 110), resulting in a voltage (the detection voltage V1) of the positive input terminal of the comparator 304 is smaller than a voltage (the common voltage VCOM) of the negative input terminal of the comparator 304. As shown in FIG. 5, in Step 704, because the voltage of the positive input terminal of the comparator 304 is smaller than the voltage of the negative input terminal of the comparator 304, the comparator 304 generates the first comparison result. In Step 706, the processing unit 306 generates the first adjustment signal to the capacitor array 302 according to the first comparison result. In Step 708, at first, the capacitor array 302 generates a compensation capacitor corresponding to 1 (2⁰) according to the first adjustment signal. In Step 710, the capacitor array 302 adds the compensation capacitor corresponding to 1 to an initial value 0 to generate a compensation capacitor corresponding to 1. Meanwhile, a present exponent n is 0. Because the compensation capacitor corresponding to 1 is still smaller than the capacitor variation 110, Step 704 to Step 710 are repeated until the detection voltage V1 is greater than the common voltage VCOM. As shown in FIG. 5, in Step 714, because the compensation capacitor corresponding to 127 is greater than the capacitor variation 110, the voltage (the detection voltage V1) of the positive input terminal of the comparator 104 is greater than the voltage (the common voltage VCOM) of the negative input terminal of the comparator 104, resulting in the comparator 304 generating the second comparison result. In Step 716, the processing unit 306 generates the second adjustment signal to the capacitor array 302 according to the second comparison result. In Step 718, the capacitor array 302 progressively decreases the present exponent 6 to generate the compensation capacitor corresponding to 32 (2⁶⁻¹) according to the second adjustment signal. In Step 720, the capacitor array 302 subtracts the compensation capacitor corresponding to 32 from the compensation capacitor corresponding to 127 (the previous compensation capacitor) to generate the compensation capacitor corresponding to 95. As shown in FIG. 5, in Step 722 and Step 724, because the compensation capacitor corresponding to 95 is smaller than the capacitor variation 110, the voltage of the positive input terminal of the comparator 104 is smaller than the voltage of the negative input terminal of the comparator 104. Therefore, the comparator 304 generates the first comparison result. In Step 726, the processing unit 306 generates the first adjustment signal to the capacitor array 302 according to the first comparison result. In Step 728, the capacitor array 302 progressively decreases the present exponent 5 to generate the compensation capacitor corresponding to 16 (2⁵⁻¹) according to the first adjustment signal. In Step 730, the capacitor array 302 adds the compensation capacitor corresponding to 16 to the compensation capacitor corresponding to 95 (the previous compensation capacitor) to generate the compensation capacitor corresponding to 111. Thus, as shown in FIG. 5, Step 714 to Step 732 are repeated until the voltage (the detection voltage V1) of the positive input terminal is equal to the voltage (the common voltage VCOM) of the negative input terminal of the comparator 104 to make the comparator 304 not generate any comparison result. That is to say, the detection voltage V1 is equal to the common voltage VCOM.

In addition, as shown in FIG. 6, when the capacitor variation caused by the object 314 is not a fixed value due to vibration of the object 314 or environmental noise of the sensing unit 308 (e.g. the capacitor variation generated by the sensing unit 308 is 1110, 100, 103, 101, 105, and 100 in turn), the sensing circuit 300 does not need to start to generate the compensation capacitor from the initial value 0. That is to say, the sensing circuit 300 only needs to repeat Step 714 to Step 732 until the compensation capacitor generated by the capacitor array 302 can match the capacitor variation generated by the sensing unit 308.

To sum up, In a practical application of the touch panel, when the capacitor variation generated by the sensing unit is larger, the sensing circuit and the operation method of the present invention can quickly make a compensation capacitor generated by the capacitor array converge toward the capacitor variation generated by the sensing unit. In addition, when the capacitor variation generated by the sensing unit is smaller, the capacitor array does not need to start to generate the compensation capacitor from the initial value, and then gradually adjust the compensation capacitor generated by the capacitor array to match the capacitor variation of the sensing unit. Thus, the present invention not only can quickly make the compensation capacitor generated by the capacitor array converge toward the capacitor variation generated by the sensing unit, but can also reduce a delay problem of compensating capacitor caused by environmental noise interference. Therefore, the present invention can increase a report rate of the touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sensing circuit of a touch panel, comprising:
a capacitor array for coupling to a plurality of sensing units of the touch panel;
a comparator coupled to each sensing unit of the touch panel and the capacitor array for comparing a detection voltage of the sensing unit with a common voltage of the touch panel to generate a corresponding comparison result; and
a processing unit for generating a corresponding adjustment signal to the capacitor array according to the corresponding comparison result;
wherein the capacitor array executes a corresponding operation on a present exponent n to generate a corresponding compensation capacitor according to the corresponding adjustment signal, and the capacitor array generates a present compensation capacitor according to a previous compensation capacitor generated by the capacitor array and the corresponding compensation capacitor, wherein n is an integer larger than or equal to 0.

2. The sensing circuit of claim 1, wherein the detection voltage is determined according to capacitor variation of the sensing unit and the present compensation capacitor.

3. The sensing circuit of claim 2, wherein the detection voltage is equal to the common voltage when the capacitor variation of the sensing unit is equal to the present compensation capacitor.

4. The sensing circuit of claim 2, wherein the detection voltage is smaller than the common voltage when the capacitor variation of the sensing unit is greater than the present compensation capacitor.

5. The sensing circuit of claim 2, wherein the detection voltage is greater than the common voltage when the capacitor variation of the sensing unit is smaller than the present compensation capacitor.

6. The sensing circuit of claim 2, wherein the capacitor array executing the corresponding operation on the present exponent n to generate the corresponding compensation capacitor according to the corresponding adjustment signal comprises:
the capacitor array starts to increase the present compensation capacitor from an initial value, wherein the initial value is equal to 0; and
the comparator generates a first comparison result, the processing unit generates a first adjustment signal to the capacitor array according to the first comparison result, and the capacitor array progressively increases the present exponent n to generate the compensation capacitor corresponding to 2ⁿ⁺¹ according to the first adjustment signal when the detection voltage is smaller than the common voltage of the touch panel.

7. The sensing circuit of claim 2, wherein the capacitor array generating the present compensation capacitor according to the previous compensation capacitor generated by the capacitor array and the corresponding compensation capacitor comprises:
the capacitor array adds the compensation capacitor corresponding to 2ⁿ⁺¹ to the previous compensation capacitor generated by the capacitor array to generate the present compensation capacitor.

8. The sensing circuit of claim 7, wherein the comparator does not generate the corresponding comparison result when the detection voltage is equal to the common voltage.

9. The sensing circuit of claim 7, wherein the capacitor array executing the corresponding operation on the present exponent n to generate the corresponding compensation capacitor according to the corresponding adjustment signal comprises:
the comparator generates a second comparison result, the processing unit generates a second adjustment signal to the capacitor array according to the second comparison result, and the capacitor array progressively decreases the present exponent n to generate the compensation capacitor corresponding to 2ⁿ⁻¹ according to the second adjustment signal when the detection voltage is greater than the common voltage of the touch panel.

10. The sensing circuit of claim 9, wherein the capacitor array generating the present compensation capacitor according to the previous compensation capacitor generated by the capacitor array and the corresponding compensation capacitor comprises:
the capacitor array subtracts the compensation capacitor corresponding to 2ⁿ⁻¹ from the previous compensation capacitor generated by the capacitor array to generate the present compensation capacitor.

11. The sensing circuit of claim 10, wherein the comparator does not generate the corresponding comparison result when the detection voltage is equal to the common voltage.

12. The sensing circuit of claim 10, wherein the capacitor array executing the corresponding operation on the present exponent n to generate the corresponding compensation capacitor according to the corresponding adjustment signal comprises:
the comparator generates the first comparison result, the processing unit generates the first adjustment signal to the capacitor array according to the first comparison result, and the capacitor array progressively decreases the present exponent n to generate the compensation capacitor corresponding to 2ⁿ⁻¹ according to the first adjustment signal when the detection voltage is smaller than the common voltage of the touch panel.

13. The sensing circuit of claim 12, wherein the capacitor array generating the present compensation capacitor according to the previous compensation capacitor generated by the capacitor array and the corresponding compensation capacitor comprises:
the capacitor array adds the compensation capacitor corresponding to 2ⁿ⁻¹ to the previous compensation capacitor generated by the capacitor array to generate the present compensation capacitor.

14. The sensing circuit of claim 13, wherein the comparator does not generate the corresponding comparison result when the detection voltage is equal to the common voltage.

15. The sensing circuit of claim 13, wherein the capacitor array executing the corresponding operation on the present exponent n to generate the corresponding compensation capacitor according to the corresponding adjustment signal comprises:
the comparator generates the second comparison result, the processing unit generates the second adjustment signal to the capacitor array according to the second comparison result, and the capacitor array progressively decreases the present exponent n to generate the compensation capacitor corresponding to 2ⁿ⁻¹ according to the second adjustment signal when the detection voltage is greater than the common voltage of the touch panel.

16. The sensing circuit of claim 15, wherein the capacitor array generating the present compensation capacitor according to the previous compensation capacitor generated by the capacitor array and the corresponding compensation capacitor comprises:
the capacitor array subtracts the compensation capacitor corresponding to 2ⁿ⁻¹ from the previous compensation capacitor generated by the capacitor array to generate the present compensation capacitor.

17. The sensing circuit of claim 16, wherein the comparator does not generate the corresponding comparison result when the detection voltage is equal to the common voltage.

18. An operation method of a sensing circuit of a touch panel, the sensing circuit comprising a capacitor array, a comparator, and a processing unit, the method comprising:
the comparator comparing a detection voltage of each sensing unit of the touch panel with a common voltage of the touch panel to generate a corresponding comparison result;
the processing unit generating a corresponding adjustment signal to the capacitor array according to the corresponding comparison result;
the capacitor array executing a corresponding operation on a present exponent n to generate a corresponding compensation capacitor according to the corresponding adjustment signal, wherein n is an integer larger than or equal to 0; and
the capacitor array generating a present compensation capacitor according to a previous compensation capacitor generated by the capacitor array and the corresponding compensation capacitor.

19. The operation method of claim 18, wherein the detection voltage is determined according to capacitor variation of the sensing unit and the present compensation capacitor.

20. The operation method of claim 19, wherein the detection voltage is equal to the common voltage when the capacitor variation of the sensing unit is equal to the present compensation capacitor.

21. The operation method of claim 19, wherein the detection voltage is smaller than the common voltage when the capacitor variation of the sensing unit is greater than the present compensation capacitor.

22. The operation method of claim 19, wherein the detection voltage is greater than the common voltage when the capacitor variation of the sensing unit is smaller than the present compensation capacitor.

23. The operation method of claim 19, wherein the capacitor array executing the corresponding operation on the present exponent n to generate the corresponding compensation capacitor according to the corresponding adjustment signal comprises:
the capacitor array starting to increase the present compensation capacitor from an initial value, wherein the initial value is equal to 0; and
the comparator generating a first comparison result, the processing unit generating a first adjustment signal to the capacitor array according to the first comparison result, and the capacitor array progressively increasing the present exponent n to generate the compensation capacitor corresponding to 2ⁿ⁺¹ according to the first adjustment signal when the detection voltage is smaller than the common voltage of the touch panel.

24. The operation method of claim 23, the capacitor array generating the present compensation capacitor according to the previous compensation capacitor generated by the capacitor array and the corresponding compensation capacitor comprises:
the capacitor array adding the compensation capacitor corresponding to 2ⁿ⁺¹ to the previous compensation capacitor generated by the capacitor array to generate the present compensation capacitor.

25. The sensing circuit of claim 24, further comprising:
the comparator does not generate the corresponding comparison result when the detection voltage is equal to the common voltage.

26. The operation method of claim 24, wherein the capacitor array executing the corresponding operation on the present exponent n to generate the corresponding compensation capacitor according to the corresponding adjustment signal comprises:
the comparator generating a second comparison result, the processing unit generating a second adjustment signal to the capacitor array according to the second comparison result, and the capacitor array progressively decreasing the present exponent n to generate the compensation capacitor corresponding to 2ⁿ⁻¹ according to the second adjustment signal when the detection voltage is greater than the common voltage of the touch panel.

27. The operation method of claim 26, wherein the capacitor array generating the present compensation capacitor according to the previous compensation capacitor generated by the capacitor array and the corresponding compensation capacitor comprises:
the capacitor array subtracting the compensation capacitor corresponding to 2ⁿ⁻¹ from the previous compensation capacitor generated by the capacitor array to generate the present compensation capacitor.

28. The sensing circuit of claim 27, further comprising:
the comparator does not generate the corresponding comparison result when the detection voltage is equal to the common voltage.

29. The operation method of claim 27, wherein the capacitor array executing the corresponding operation on the present exponent n to generate the corresponding compensation capacitor according to the corresponding adjustment signal comprises:
the comparator generating the first comparison result, the processing unit generating the first adjustment signal to the capacitor array according to the first comparison result, and the capacitor array progressively decreasing the present exponent n to generate the compensation capacitor corresponding to 2ⁿ⁻¹ according to the first adjustment signal when the detection voltage is smaller than the common voltage of the touch panel.

30. The operation method of claim 29, wherein the capacitor array generating the present compensation capacitor according to the previous compensation capacitor generated by the capacitor array and the corresponding compensation capacitor comprises:
the capacitor array adding the compensation capacitor corresponding to 2ⁿ⁻¹ to the previous compensation capacitor generated by the capacitor array to generate the present compensation capacitor.

31. The sensing circuit of claim 30, further comprising:
the comparator does not generate the corresponding comparison result when the detection voltage is equal to the common voltage.

32. The operation method of claim 30, wherein the capacitor array executing the corresponding operation on the present exponent n to generate the corresponding compensation capacitor according to the corresponding adjustment signal comprises:
the comparator generating the second comparison result, the processing unit generating the second adjustment signal to the capacitor array according to the second comparison result, and the capacitor array progressively decreasing the present exponent n to generate the compensation capacitor corresponding to 2ⁿ⁻¹ according to the second adjustment signal when the detection voltage is greater than the common voltage of the touch panel.

33. The operation method of claim 32, wherein the capacitor array generating the present compensation capacitor according to the previous compensation capacitor generated by the capacitor array and the corresponding compensation capacitor comprises:
the capacitor array subtracting the compensation capacitor corresponding to 2ⁿ⁻¹ from the previous compensation capacitor generated by the capacitor array to generate the present compensation capacitor.

34. The sensing circuit of claim 33, further comprising:
the comparator does not generate the corresponding comparison result when the detection voltage is equal to the common voltage.
